(19) United States
(12) Patent Application Publication
(10) Pub. No.: US 2010/0011110 A1
(43) Pub. Date: Jan. 14, 2010

(54) Mobile terminal to media server connection apparatus, system, and method

(75) Inventors: Klaus Doppler, Espoo (FI); Cassio Ribeiro, Espoo (FI); Carl S. Wijting, Helsinki (FI); Klaus Hugl, Helsinki (FI); Mika P. Rinne, Espoo (FI); Juha S. Korhonen, Espoo (FI); Timo Eric Roman, Espoo (FI)

Correspondence Address: SQUIRE, SANDERS & DEMPSEY L.L.P., 8000 TOWERS CRESCENT DRIVE, 14TH FLOOR, VIENNA, VA, 22182-6212, US

(73) Assignee: Nokia Corporation

(21) Appl. No.: 12/216,953

(22) Filed: Jul. 14, 2008

(51) Int. Cl. G06F 15/16

(52) U.S. Cl. 709/228

(57) ABSTRACT

An apparatus, system, and method for a communication network that includes base stations, mobile terminals, and media servers. A base station may receive enable a device-to-device connection between a media server and a mobile terminal. The mobile terminal and the media server may establish the enabled device-to-device connection to create an underlay network within the cellular network, the underlay network including the mobile terminal, the media server, and the device-to-device connection. In some embodiments, the mobile terminal and the media server each include a device-to-device radio that is used to establish and maintain the device-to-device connection.

### BACKGROUND OF THE INVENTION

1. Field of the Invention

The present invention relates generally to cellular networks. More specifically, the present invention relates to apparatuses, systems, and methods for device-to-device connections.

2. Description of the Related Art

Cellular networks often include multiple user terminals in a radio cell served by a base station. In many cellular networks, when two user terminals communicate with one another, all such communications must flow through the base station regardless of the physical distance separating the user terminals. Though such networks enable communication between two user terminals, such network are undesirably inefficient by requiring all communications to be sent via the base station.

In light of this deficiency, certain technologies have been used to enable user terminals to communicate with one another without involving the base station. Such technologies include wireless local area network (WLAN) technologies, Bluetooth technologies, and Ultra-wideband (UWB) radio technologies. Though these technologies may enable user terminals to communicate at least to a certain degree, the currently available technologies have certain deficiencies.

For example, enabling a WLAN or UWB system often involves device configuration, access point maintenance, and user data entry. Another example is the pairing process of Bluetooth technology, where a user is required to enter data, such as the secret passkey, into each Bluetooth device. As such, currently available device-to-device communication technologies require an undesirable amount of data entry and device configuration from a user and/or network administrator standpoint.

### SUMMARY OF THE INVENTION

The present invention has been developed in response to the present state of the art, and in particular, in response to the problems and needs in the art that have not yet been fully solved by currently available communication system technologies. Accordingly, the present invention has been developed to enable a mobile device to media server connection apparatus, system, and method.

In one embodiment of the present invention, a method includes enabling a device-to-device connection between a media server and a mobile terminal by creating an underlay network within a cellular network, the underlay network comprising the mobile terminal in communication with the media server via the device-to-device connection. In certain embodiments, at least part of the enabling is performed by a base station in communication with the media server and the mobile terminal.

In some embodiments, the method may also include receiving a request from the mobile terminal to establish the device-to-device connection with the media server. In certain embodiments, the method may also include detecting device-to-device traffic within the cellular network. The method may further include classifying traffic corresponding to device-to-device connections as device-to-device traffic and communicating connection availability data to the mobile terminal, the connection availability data configured to indicate an opportunity to establish a device-to-device connection with the media server.

In certain embodiments, the connection availability data comprises data associated with the media server. In certain embodiments, the data associated with the media server comprises at least one of a phone number, a session initiation protocol address, and a universal resource locator corresponding to the media server. Additionally, the device-to-device connection may be facilitated by a device-to-device radio of the media server and the mobile terminal.

In some embodiments, the method also includes registering the media server with the cellular network and receiving attribute data from at least one of the media server and the mobile terminal. In certain embodiments, the method further includes determining an estimation of device-to-device traffic corresponding to the media server, assigning resources for device-to-device connections, and/or coordinating with other networks to manage roaming mobile terminals establishing a device-to-device connection with the media server. The coordinating may be facilitated by a web service.

In another embodiment of the present invention, a device-to-device connection enablement unit configured to enable a device-to-device connection between a media server and a mobile terminal to create an underlay network within a cellular network, the underlay network comprising the mobile terminal in communication with the media server via the device-to-device connection. The apparatus may also include a reception unit configured to receive a request from the mobile terminal to establish the device-to-device connection with the media server, and a device-to-device traffic detection unit configured to detect device-to-device traffic within the cellular network.

In certain embodiments, the apparatus also includes a traffic classification unit configured to classify traffic corresponding to device-to-device connections as device-to-device traffic. In some embodiments, the apparatus also includes a transmission unit configured to transmit connection availability data to the mobile terminal, the connection availability data configured to indicate an opportunity to establish a device-to-device connection with the media server. The connection availability data may include data associated with the media server.

In certain embodiments, the data associated with the media server may include at least one of a phone number, a session initiation protocol address, and a universal resource locator corresponding to the media server. The device-to-device connection may be facilitated by a device-to-device radio of the media server and the mobile terminal. The apparatus may also include a registration unit configured to register the media server with the cellular network.

In certain embodiments, the apparatus may include a reception unit configured to receive attribute data from at least one of the media server and the mobile terminal, and a device-to-device estimation unit configured to determine an estimation of device-to-device traffic corresponding to the media server. In some embodiments, the apparatus may also include a resource assignment unit configured to assign network resources for device-to-device connections.

In certain embodiments, the apparatus also includes a roaming terminal unit configured to manage roaming mobile terminals establishing a device-to-device connection with the media server. The management of the roaming mobile terminals may be facilitated by a web service. The apparatus may be a base station in communication with the media server and the mobile terminal.

In another embodiment of the present invention, an apparatus includes a means for enabling a device-to-device connection between a media server and a mobile terminal to create an underlay network within the cellular network, the underlay network comprising the mobile terminal in communication with the media server via the device-to-device connection.

In another embodiment of the present invention, a computer program is embodied on a computer-readable medium. The computer program may be configured to control a processor to perform operations that include enabling a device-to-device connection between a media server and a mobile terminal to create an underlay network within the cellular network, the underlay network comprising the mobile terminal in communication with the media server via the device-to-device connection.

In another embodiment of the present invention, a method may include establishing a device-to-device connection with a media server to create an underlay network within a cellular network, the underlay network comprising the device-to-device connection with the media server. In some embodiments, the method may also include transmitting a request to a base station to establish the device-to-device connection with the media server, wherein the base station is configured to enable the device-to-device connection. In some embodiments, the transmitting of the request comprises transmitting data corresponding to at least one of a phone number, a session initiation protocol address, and a universal resource locator corresponding to the media server.

In some embodiments, the method may also include receiving connection availability data from a base station, the connection availability data configured to indicate an opportunity to establish a device-to-device connection with the media server. The establishing of the device-to-device connection may include using a local device-to-device radio to communicate with a device-to-device radio of the media server, and at least part of the establishing may be performed by a mobile terminal in the cellular network.

In another embodiment of the present invention, an apparatus includes a device-to-device connection establishment unit configured to establish a device-to-device connection with a media server to create an underlay network within a cellular network, the underlay network comprising the device-to-device connection with the media server. In certain embodiments, the apparatus includes a transmission unit configured to transmit a request to a base station of the cellular network to establish a device-to-device connection with the media server, wherein the base station is configured to enable the device-to-device connection. The request may include transmitting data corresponding to at least one of a phone number, a session initiation protocol address, and a universal resource locator corresponding to the media server.

In certain embodiments, the traffic corresponding to the device-to-device connection is classified as device-to-device traffic by the base station. In some embodiments, the apparatus may include a reception unit configured to receive connection availability data from a base station, the connection availability data configured to indicate an opportunity to establish a device-to-device connection with the media server. In certain embodiments, the device-to-device connection establishment unit is configured to establish the device-to-device connection by using a local device-to-device radio to communicate with a device-to-device radio of the media server. The apparatus may be a mobile terminal in the cellular network.

In another aspect of the present invention, an apparatus includes a means for establishing a device-to-device connection with a media server to create an underlay network within the cellular network, the underlay network comprising the device-to-device connection with the media server.

In another embodiment of the present invention, a computer program is embodied on a computer-readable medium. The computer program may be configured to control a processor unit to perform operations that include establishing a device-to-device connection with a media server to create an underlay network within the cellular network, the underlay network comprising the device-to-device connection with the media server.

In another aspect of the present invention, a method includes establishing a device-to-device connection with the mobile device to create an underlay network within the cellular network, the underlay network comprising the device-to-device connection with the mobile device. In certain embodiments, the method includes receiving device-to-device connection enablement data regarding the mobile terminal from a base station of the cellular network.

In some embodiments, the method also includes displaying communicating connection availability data to enable establishment of the device-to-device connection with the mobile device. The connection availability data may include at least one of a phone number, a session initiation protocol address, and a universal resource locator corresponding to the media server. In certain embodiments, the establishing of the device-to-device connection comprises using a local device-to-device radio to communicate with a local device-to-device radio of the mobile terminal.

In some embodiments, the method also includes registering with the cellular network and communicating attribute data to the base station. In certain embodiments, the establishing is performed by a media server in the cellular network.

In another embodiment of the present invention, an apparatus includes a device-to-device connection unit configured to establish a device-to-device connection with a mobile device to create an underlay network within the cellular network, the underlay network comprising the device-to-device connection with the mobile device. In certain embodiments, the apparatus also includes a reception unit configured to receive device-to-device connection enablement data regarding the mobile terminal from a base station of the cellular network.

In some embodiments, the apparatus also includes a display unit configured to communicate connection availability data to enable establishment of the device-to-device connection with the mobile device. The connection availability data may include at least one of a phone number, a session initiation protocol address, and a universal resource locator corresponding to the media server. In some embodiments, the device-to-device connection unit is configured to establish the device-to-device connection by using a local device-to-device radio to communicate with a local device-to-device radio of the mobile terminal.

In certain embodiments, the apparatus further includes a reception unit and a transmission unit configured to enable the apparatus to register with the cellular network, and a transmission unit configured to transmit attribute data to the base station. In some embodiments, the apparatus is a media server in a cellular network.

In another embodiment of the present invention, an apparatus includes a means for establishing a device-to-device connection with a mobile device to create an underlay network within the cellular network, the underlay network comprising the device-to-device connection with the mobile device.

In another embodiment of the present invention, a computer program is embodied on a computer-readable medium. The computer program may be configured to control a processor to perform operations that include establishing a device-to-device connection with a mobile device to create an underlay network within the cellular network, the underlay network comprising the device-to-device connection with the mobile device.

In another embodiment of the present invention, a mobile terminal includes a device-to-device connection unit configured to establish a device-to-device connection with a mobile device to create an underlay network within the cellular network, the underlay network comprising the device-to-device connection with the mobile device, wherein the mobile terminal operates as a media server.

In another embodiment of the present invention, a system includes a base station of a cellular network, a mobile terminal, and a media server. The base station may be configured to enable a device-to-device connection between the media server and the mobile terminal. Additionally, the mobile terminal and the media server may be configured to establish the device-to-device connection to create an underlay network within the cellular network, the underlay network comprising the mobile terminal, the media server, and the device-to-device connection.

### BRIEF DESCRIPTION OF THE DRAWINGS

In order that the advantages of the invention will be readily understood, a more particular description of the invention briefly described above will be rendered by reference to specific embodiments that are illustrated in the appended drawings. Understanding that these drawings depict only typical embodiments of the invention and are not therefore to be considered to be limiting of its scope, the invention will be described and explained with additional specificity and detail through the use of the accompanying drawings, in which:

FIG. 1 is a block diagram of a mobile terminal to media server connection system in accordance with the present invention;

FIG. 2 is a block diagram of a base station in accordance with one embodiment of the present invention;

FIG. 3 is a block diagram of a mobile terminal in accordance with one embodiment of the present invention;

FIG. 4 is a block diagram of a media server in accordance with one embodiment of the present invention;

FIG. 5A is a flow chart diagram of a method for a base station setting up a media server in accordance with one embodiment of the present invention;

FIG. 5B is a flow chart diagram of a method for a base station enabling a device-to-device connection in accordance with the present invention;

FIG. 5C is a flow chart diagram of a method for a base station detecting and classifying device-to-device traffic in accordance with the present invention;

FIG. 6 is a flow chart diagram of a method for a mobile terminal requesting and establishing a device-to-device connection, in accordance with an embodiment of the present invention;

FIG. 7A is a flow chart diagram of a method 700a for a media server registering with a cellular network and self-advertising connection availability data in accordance with one embodiment of the present invention;

FIG. 7B is a flow chart diagram of a method 700b for a media server establishing a connection with and providing services to a mobile terminal in accordance with one embodiment of the present invention;

FIG. 8 is a block diagram of a system comprising a single base station and multiple media servers in accordance with one embodiment of the present invention; and

FIG. 9 is a block diagram of a system comprising multiple base stations sharing a single media server in accordance with one embodiment of the present invention.

### DETAILED DESCRIPTION OF THE PREFERRED EMBODIMENT(S)

It will be readily understood that the components of the present invention, as generally described and illustrated in the figures herein, may be arranged and designed in a wide variety of different configurations. Thus, the following more detailed description of the embodiments of the apparatus, system, and method of the present invention, as represented in the attached figures, is not intended to limit the scope of the invention, as claimed, but is merely representative of selected embodiments of the invention.

The features, structures, or characteristics of the invention described throughout this specification may be combined in any suitable manner in one or more embodiments. For example, reference throughout this specification to “certain embodiments,” “some embodiments,” or similar language means that a particular feature, structure, or characteristic described in connection with the embodiment is included in at least one embodiment of the present invention. Thus, appearances of the phrases “in certain embodiments,” “in some embodiment,” “in other embodiments,” or similar language throughout this specification do not necessarily all refer to the same group of embodiments and the described features, structures, or characteristics may be combined in any suitable manner in one or more embodiments.

In addition, while the terms, data, packet, and/or datagram have been used in the description of the present invention, the invention has import to many types of network data. For purposes of this invention, the term data includes packet, cell, frame, datagram, bridge protocol data unit packet, packet data and any equivalents thereof.

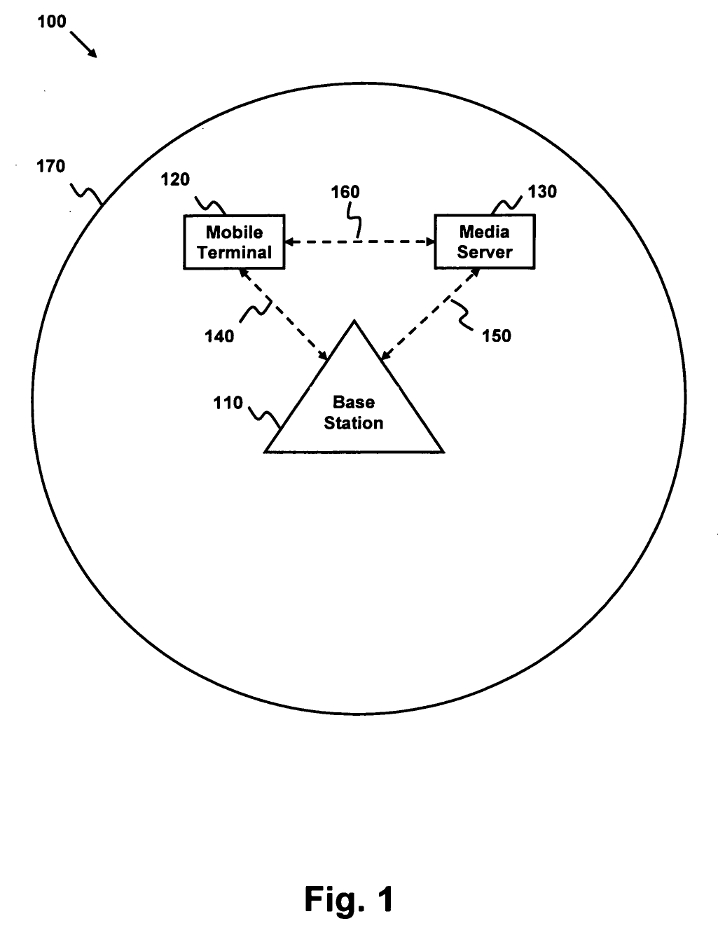

FIG. 1 is a block diagram of a mobile terminal to media server connection system 100 in accordance with the present invention. The depicted system 100 includes a base station 110, a mobile terminal 120, and a media server 130. In certain embodiments, the base station 100 is an enhanced Node B (eNodeB) or a worldwide interoperability for microwave access (WiMAX) base station (also referred to as “BS”). In some embodiments, some devices of the system 100 cooperate to establish an underlay network/underlay networks in the form of a device-to-device (also referred to as “D2D”) connection 160 between the mobile terminal and the media server.

In some embodiments the underlay network is a network that operates in the same frequency band as the system 100. The underlay network may operate on the same resources (time slot, frequency slot, spreading code, OFDMA resource block, a combination thereof, etc.) or use separate resources within the frequency band. A device-to-device connection may include a connection, where at least some or all of the data is transmitted directly between two devices. In some embodiments the user plane data is transmitted directly and part or all of the control plane data is transmitted via the base station. Additionally, the device-to-device connection can be established using multiple device-to-device connections that form a multi-hop connection.

In certain embodiments, the mobile terminal 120 communicates with the base station 110 via connection 140 to request a device-to-device connection 160 with the media server 130. In some embodiments, the base station 110 may be configured to detect device-to-device traffic in a cell of the base station or in a neighboring cell. The base station 110 may be configured to communicate with the media server 130 via connection 150 to enable the device-to-device connection 160 between the mobile terminal 120 and the media server 130. In certain embodiments, establishing the device-to-device connection 160 is achieved using device-to-device (D2D) radios that operate as underlay network.

The D2D radio can be an underlay network to networks including but not limited to 3GPP HSPA and long term evolution radio network and its evolutions as defined by 3GPP or a WiMAX radio network as defined by IEEE 802.16 and its evolutions or a Universal Mobile Broadband (UMB) network and its evolutions.

When setting up or after setting up the device-to-device connection 160, the base station 110 may also classify traffic to and from the media server 130 as device-to-device traffic so that traffic between the media server 130 and the mobile terminal 120 does not increase cellular network traffic. In certain embodiments, the device-to-device connection 160 enables the mobile device 120 to exchange data with the media server 130 and receive additional telecommunication services. Accordingly, the base station 110, mobile terminal 120, and media server 130 cooperate to create an underlay network to a cellular network by establishing a device-to-device connection 160. In some embodiments the connection between the mobile terminal 120 and the media server 130 may be setup using the cellular network. The cellular network may then detect traffic between two devices within the same or neighboring cells and may try to establish a device-to-device connection between the mobile terminal 120 and the media server 130.

One skilled in the art will appreciate the many types of services may be provided by the media server. Such services may include downloading promotional material or uploading videos and pictures during a public event such as a music concert or sporting event. Additionally, such services may include downloading tourist information including maps, schedules, promotional materials, pictures of tourists, and pictures of attractions. Furthermore, such services may include accessing shopping related information such as store locations, sales, and hours of operation. Accordingly, establishing the device-to-device connection 160 between the mobile terminal 120 and the media server 130 provides access to a great variety of desirable services.

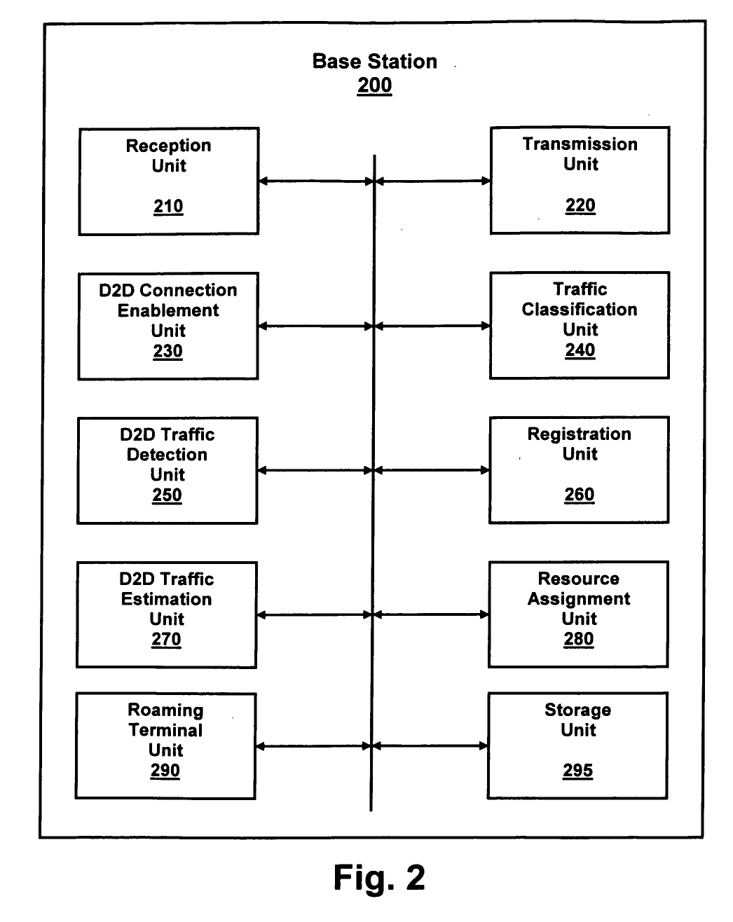

FIG. 2 is a block diagram of a base station 200, in accordance with one embodiment of the present invention. The depicted base station 200 includes a receiver or a reception unit 210, a transmitter or a transmission unit 220, a device-to-device (D2D) connection enablement connector or connection unit 230, a traffic classification unit 240, a D2D traffic detection unit 250, a registration unit 260, a D2D traffic estimation unit 270, a resource assignment unit 280, a roaming terminal coordination unit 290, and a storage unit 295. One skilled in the art will appreciate that the depicted base station 200 may include additional components, units, features, or members that are consistent with base stations known in the art, and such features are incorporated herein. In some embodiments, the base station 200 may correspond to the base station 110 of FIG. 1. The units of the base station 200 cooperate to enable a device-to-device connection between a mobile terminal (not shown) and a media sever (also not shown).

In certain embodiments, the reception unit 210 and the transmission unit 220 are configured to enable and/or facilitate communication between the base station 200 and other network nodes, such as a mobile terminal and a media server. For example, in certain embodiments, the transmission unit 220 may be configured to communicate connection availability data to the mobile terminal. The connection availability data may be configured to indicate an opportunity to establish a device-to-device connection with the media server. In certain embodiments, the connection availability data may include an advertisement transmitted via a short message server (SMS) or a cell broadcast message.

Additionally, the connection availability data may include a variety of data such as a phone number, a session initiation protocol (SIP) address, a universal resource locator (URL), or a media server identity (ID). However, it should be noted that any data identifying the media server may be used regardless of the type or format. The base station 200 may receive the connection availability data from various sources including the media server. One skilled in the art will appreciate the great variety of data that may be transmitted to a mobile terminal to indicate that a device-to-device connection may be established between the mobile terminal and the media server. Accordingly, the base station 200 may proactively advertise device-to-device connections to mobile terminals and mobile terminal users.

In some embodiments, the reception unit 210 may be configured to receive a request from a mobile terminal to establish a device-to-device connection with a media server. In some embodiments, the request may be made in response to an advertisement transmitted to the terminal device. In certain embodiments, the request may include a phone number, a SIP address, a URL, a media server ID, or other data fit for making the request. In some embodiments, the D2D connection enablement unit 230 is configured to enable the device-to-device connection, which may include providing data and instructions to the media server regarding establishing the connection. As such, a user of a mobile device need only, for example, call a phone number corresponding to the media server to establish a device-to-device connection with the media server.

In certain embodiments, the traffic classification unit 240 is configured to classify traffic between devices in the same or neighboring cells as device-to-device traffic and then the base station 200 facilitates a device-to-device connection setup between a mobile terminal and a media server for the traffic between the mobile terminal and the media server. Thus, this traffic does not create excessive traffic in the cellular network. In some embodiments, the traffic classification unit 240 is located in at a different node in the cellular network or it may request assistance from another node. In certain embodiments, the D2D traffic detection unit 250 is configured to detect that communication going on between devices can be classified as D2D traffic and moved to D2D radio. In such a scenario, the base station 200 may operate to enable and classify a D2D connection in accordance with the detected D2D traffic.

In some embodiments, the registration unit 250 is configured to register a media server with a cellular network of the base station 200. In some embodiments, registering the media server enables the base station 200 to reallocate network resources to device-to-device connections and/or advertising device-to-device connections with the media server.

In certain embodiments, the D2D traffic estimation unit 260 is configured to estimate an amount of device-to-device traffic that a media server may experience. In some embodiments, the estimation may be at least partially based on data received from the media server during or after registration of the media server. The resource assignment unit 270 may be configured to assign network resources to device-to-device connections of one or more media servers.

In some embodiments, the network resources assigned to a media server may be at least partially based on one or more estimations made by the device-to-device traffic estimation unit 270. The network resources assigned to the media server may also be at least partially based on data received directly from the media server and/or the mobile terminal.

In certain embodiments, the resource assignment unit 280 and the registration unit 260 may cooperate to assign or allocate network resources to a media server during or after a registration process. In some embodiments, such a resource allocation only occurs if the media server is going to self-advertise media server services or if there are currently mobile terminal media server connections active. Typically, however, network resources are assigned to the media server only after a D2D connection request is received from a mobile device. As such, the base station 200 improves spectral efficiency by assigning or allocating network resources after considering network resource needs.

In certain embodiments, the roaming terminal coordination unit 280 is configured to enable the base station 200 to coordinate with other base stations or networks to manage roaming user terminals that are or intend to establish a device-to-device connection with a media server registered to the base station 200. As such, the base station 200 may be capable of device-to-device connections between a media server and one or more roaming mobile terminals.

In some embodiments, the base station 200 may include a storage unit 295 that is configured to store one or more data structures or commands for performing the operations described herein. One skilled in the art will appreciate that the storage 295 unit may include a large variety of computer-readable mediums such as volatile or non-volatile memory storing one or more computer programs. Additionally, one skilled in the art will appreciate that base station 200 may be configured to simultaneously support and/or enable device-to-device connections for multiple mobile terminals and multiple media servers. In doing so, the base station 200 enhances telecommunication networks by enabling users to have access to additional services and by increasing spectral efficiency.

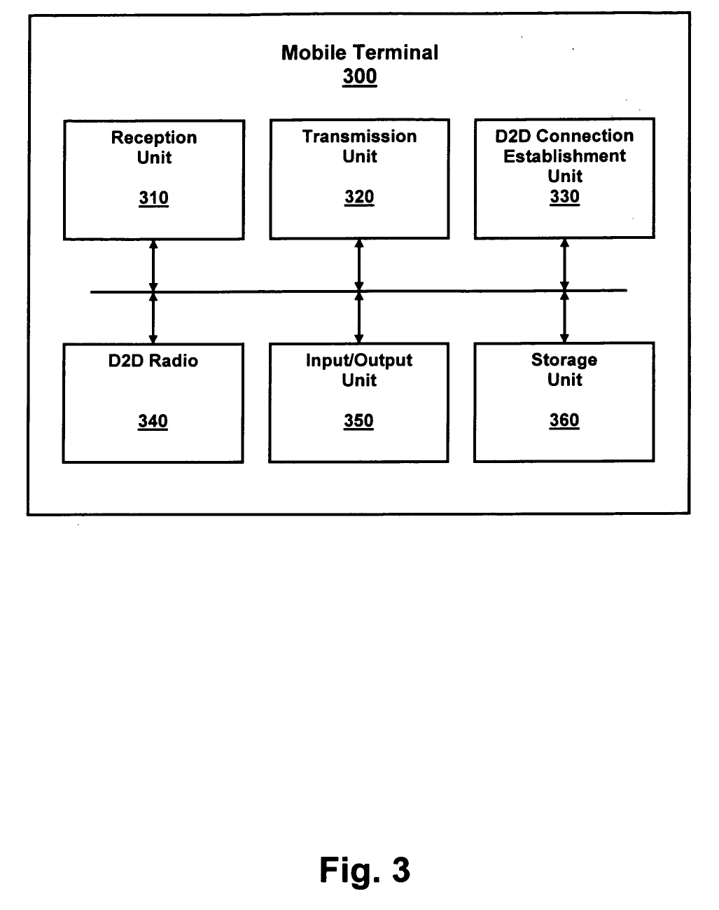

FIG. 3 is a block diagram of a mobile terminal 300, in accordance with one embodiment of the present invention. The depicted mobile terminal 300 includes a receiver or a reception unit 310, a transmitter or a transmission unit 320, a device-to-device (D2D) connector or connection establishment unit 330, a D2D radio 340, an input/output unit 350, and a storage unit 360. In certain embodiments, the mobile terminal 300 corresponds to the mobile terminal 120 of FIG. 1. Additionally, the components of the mobile terminal 300 cooperate to establish a device-to-device connection with a media server (not shown) by communicating with a base station (also not shown).

In some embodiments, the reception unit 310 and the transmission unit 320 are configured to enable communications between the mobile terminal 300 and one or more base stations. In certain embodiments, the reception unit 310 and the transmission unit 320 may operationally cooperate or include a cellular radio (not shown) such as an LTE radio or a WiMAX radio or an ultra mobile broadband (UMB) radio or any other radio network in general.

In some embodiments, the reception unit 310 is configured to receive connection availability data from the base station. In certain embodiments, the connection availability data indicates an opportunity to establish a device-to-device connection with a media server. The connection availability data may include an advertisement, an invitation, or a notification of the device-to-device connection availability. In certain embodiments, the input/output unit 350 may display at least a portion or a representation of the connection availability data to a user. Displaying the connection availability data enables the user to decide whether or not to seek a connection with the media server. In some embodiments, the information displayed may include descriptive content representative of the service(s) provided by the media server.

In some embodiments, the transmission unit 320 is configured to transmit a request to a base station to establish a device-to-device connection with a media server. The transmission unit 320 may also be configured to communicate attribute data to the base station, especially in scenarios where the mobile terminal 300 uploads multimedia data. In some embodiments, the attribute data may be used by the base station to enable D2D connections and assign or allocate resources thereto. In certain embodiments, a mobile terminal user may initiate the request by merely entering in phone number, universal resource locator (URL) of the media server, or other small amount of data via the input/output unit 350.

In certain embodiments, the D2D connection establishment unit 330 may establish a secure device-to-device connection with a media server. In some embodiments, the D2D connection establishment unit 330 cooperates with the D2D radio 340 to establish the device-to-device connection. Establishment of the device-to-device connection may be facilitated by the base station communicating with the mobile terminal 300 and/or the media server to provide the necessary commands and/or data for doing so. Accordingly, the mobile device 300 facilitates device-to-device connection establishment by involving the base station.

In some embodiments, the mobile terminal 300 includes a cellular radio (not shown) that shares radio resources with the D2D radio 340. In certain embodiments, the storage unit 360 may include volatile and/or non-volatile memory storing any number of data structures or commands for performing the functions and operations attributed to a mobile terminal of the present invention. Accordingly, the components of the mobile terminal 300 collaborate to establish a device-to-device connection with a media server by communicating with a base station.

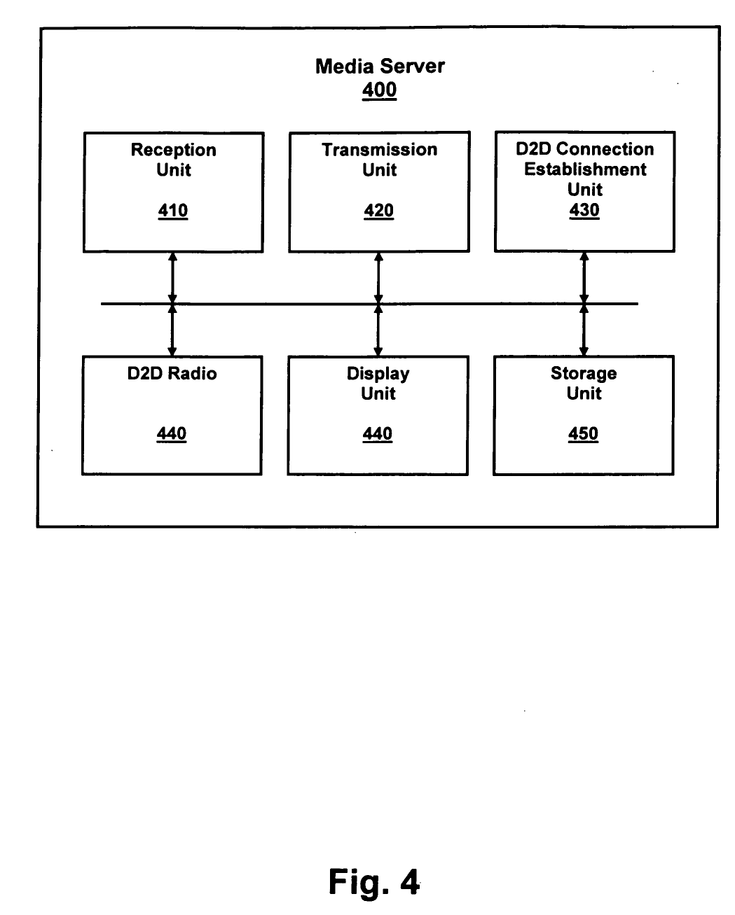

FIG. 4 is a block diagram of a media server 400, in accordance with one embodiment of the present invention. The depicted media server 400 includes a reception unit 410, a transmission unit 420, a device-to-device (D2D) connection establishment unit 430, a D2D radio 440, a display unit 440, and a storage unit 450. One skilled in the art will appreciate that the media server 400 may include additional features, structures, or components that contribute to a platform for communicating in a cellular communication network. In certain embodiments, the media server 400 corresponds to the media server 130 of FIG. 1. In some embodiments, the media server 400 may be a mobile terminal. The components of the media server 400 function to establish a device-to-device connection with a mobile terminal (not shown) by communicating with a base station (also not shown).

In certain embodiments, the reception unit 410 and the transmission unit 420 enable the media server 400 to communicate with a base station. In some embodiments, the reception unit 410 and the transmission unit 420 include a cellular radio that operates using the same radio resources as the D2D radio 440 and the base station may control the interference from the D2D radio 440 to the cellular network. In some embodiments, the base station may control the D2D radio to limit the interference to the cellular network.

In certain embodiments, the reception unit 410 receives device-to-device connection enablement data regarding a mobile terminal from the base station. The device-to-device connection enablement data may be used by the D2D connection establishment unit 430 to establish a device-to-device connection with the mobile device. In certain embodiments, the device-to-device connection is established and maintained using the D2D radio 440.

In certain embodiments, the display unit 440 is configured to display connection availability data to enable establishment of a device-to-device connection with a mobile device. In some embodiments, the display unit may include an electronic screen or a sign indicating a phone number, session initiation protocol (SIP) address, universal resource locator (URL), or the like. Consequently, a mobile terminal user may view the connection availability data and call the phone number shown in the display to set up a device-to-device connection with the media server. In certain embodiments the display unit may be a label printed on the media server. In certain embodiments the display unit may not be present. In such embodiments, a base station may advertise a callable identity of the media server.

In certain embodiments, the reception unit 410 and the transmission unit 420 enable the media server 400 to register with the cellular network by communicating with the base station. Additionally, the reception unit 410 and the transmission unit 420 may communicate attribute data to the base station to enable the base station to better allocate network resources for device-to-device connections. Accordingly, the media server 400 provides a solution for registering in cellular network, aiding in the allocation of network resources, and establishing a device-to-device connection with a mobile terminal.

It should be noted that many of the functional units described in this specification have been presented as units in order to more particularly emphasize their implementation independence. For example, a unit may be implemented as a hardware circuit comprising custom VLSI circuits or gate arrays, off-the-shelf semiconductors such as logic chips, transistors, or other discrete components. A unit may also be implemented in programmable hardware devices such as field programmable gate arrays, programmable array logic, programmable logic devices or the like.

Units may also be partially implemented in software for execution by various types of processors. An identified unit of executable code may, for instance, comprise one or more physical or logical blocks of computer instructions which may, for instance, be organized as an object, procedure, or function. Nevertheless, the executables of an identified unit need not be physically located together, but may comprise disparate instructions stored in different locations which, when joined logically together, comprise the unit and achieve the stated purpose for the unit.

Indeed, a unit of executable code could be a single instruction, or many instructions, and may even be distributed over several different code segments, among different programs, and across several memory devices. Similarly, operational data may be identified and illustrated herein within units, and may be embodied in any suitable form and organized within any suitable type of data structure. The operational data may be collected as a single data set, or may be distributed over different locations including over different storage devices, and may exist, at least partially, merely as electronic signals on a system or network.

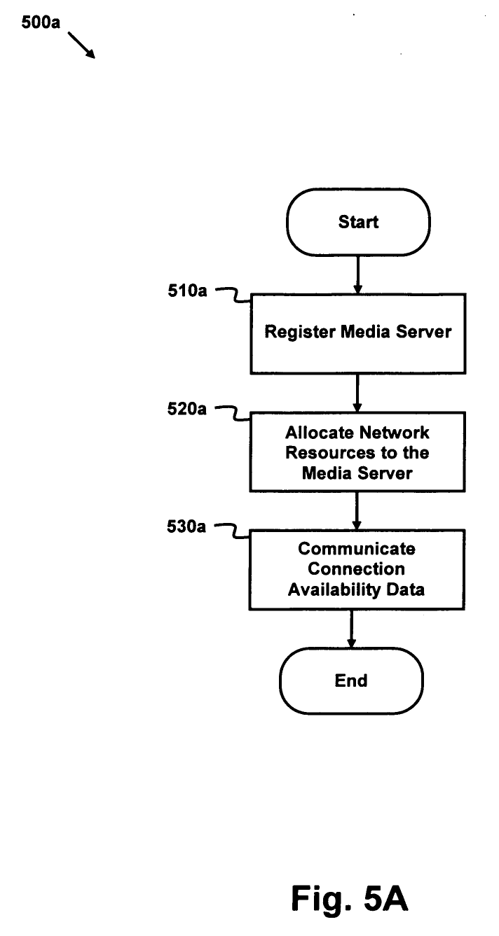

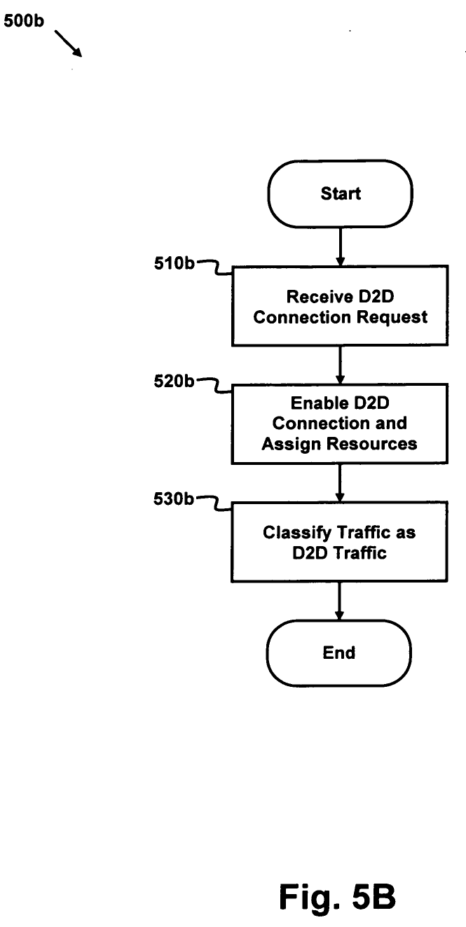

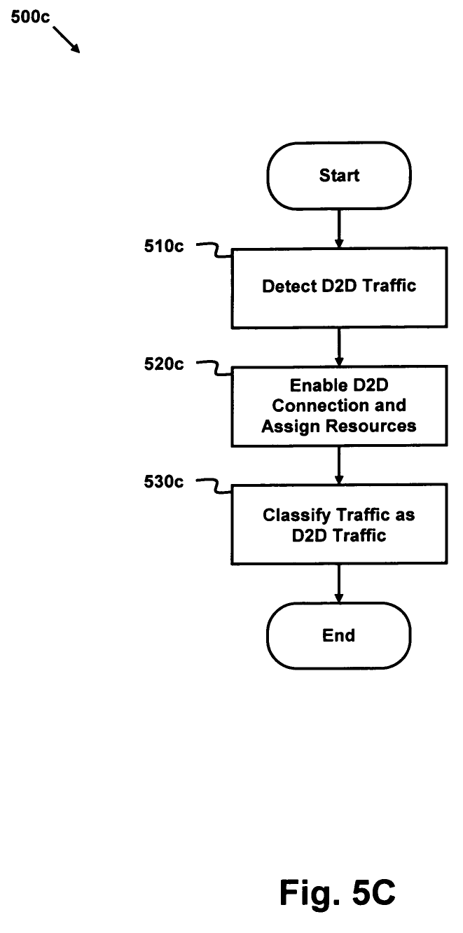

FIG. 5A is a flow chart diagram of a method 500a for setting up a media server and advertising a device-to-device connection in accordance with one embodiment of the present invention. The depicted method 500a includes registering 510a a media server, allocating 520a network resources to a media server, and communicating 520a connection availability data. In certain embodiments, the operations of method 500a may be performed by a base station such as an enhanced Node B (eNodeB), WiMAX Access Point, ultra mobile broadband (UMB) Access Point or similar. In some embodiments, the allocating 520a and communicating 530a are optional.

Registering 510 may include a base station registering a media server with a cellular network and receiving attribute data from the media server. It should be noted that the base station may also receive attribute data from a mobile device. In certain embodiments, the attribute data may indicate a capacity that the media server has for device-to-device connections. In some embodiments, this may occur in response to a media server being introduced into a cell of the base station. Allocating 520a network resources to a media server may include a base station enabling the media server to use network resources. In some embodiments, the allocating 520a operation is optional and may depend on whether the media server is able to proactively advertise media server services or where mobile terminal to media server connections are already active.

Communicating 530a connection availability data may include the base station communicating data to one or more mobile devices to indicate that the mobile devices may establish a device-to-device connection with the media server. Communicating 530a may include the base station communicating with mobile terminals via short message service (SMS) or cell broadcast message to advertise the services of the media server. In some embodiments, communicating 530a may include a base station communicating according to a cross-advertisement agreement, where the base station advertises a media server that is in a different cellular network or location.

In certain embodiments, the communicating 530a operations is entirely optional and may depend on requests, commands, capacities, attributes or other data communicated to the base station. In some embodiments, at least some of the connection availability data is received from the media server during, or after, the registering 510a. Accordingly, the method 500a provides a sequence of operations for registering a media server in a cellular network, allocating network resources to the media server, and advertising a device-to-device connection in accordance with the present invention.

FIG. 5B is a flow chart diagram of a method 500b for a base station enabling a device-to-device connection in accordance with the present invention. The depicted method 500b includes receiving 510b a D2D connection request, enabling 520b a D2D connection and assigning network resources, and classifying 530b traffic as D2D traffic. Similar to the operations of method 500a FIG. 5A, the operations of the method 500b may be performed by a base station such as an enhanced Node B (eNodeB), WiMAX Access Point, ultra mobile broadband (UMB) Access Point or similar.

Receiving 510b a D2D connection request may include the base station receiving a request from a mobile terminal to establish a device-to-device connection with the media server. Enabling 520b the D2D connection and assigning 520b resources may include the base station providing the media server with data and instructions for establishing the device-to-device connection. Enabling 550 may also include the base station using an identifier (ID) of the media server to setup the device-to-device connection.

In certain embodiments, assigning 520b may include evaluating the attribute data received from the media server and determining a network resources estimate based thereon. In some embodiments, a base station may evaluate the resource availability based on media server attribute data without enacting limitations based thereon. Allocating 520 may also involve considering other media servers that may be in the area and a current or expected level of traffic per mobile terminal. Classifying 560 traffic as D2D traffic may include the base station classifying all traffic to and from the media server as D2D traffic and to enable a D2D connection to avoid an increase in cellular network traffic. Accordingly, the method 500b provides one example of a solution for enabling a device-to-device connection in accordance with the present invention.

FIG. 5C is a flow chart diagram of a method 500c for a base station detecting and classifying device-to-device traffic in accordance with the present invention. The depicted method 500c includes detecting 510c D2D traffic, enabling 520c a D2D connection and assigning resources, and classifying 530c traffic as D2D traffic. Similar to the operations of methods 500a and 500b of FIGS. 5A and 5B, the operations of the method 500c may be performed by a base station such as an enhanced Node B (eNodeB), WiMAX Access Point, ultra mobile broadband (UMB) Access Point or similar.

Detecting D2D traffic may include a base station identifying traffic between one or more devices in the same or neighboring cells as device-to-device traffic. After detecting 510c the D2D traffic, may enable 520c a D2D connection and assign 520c resources for the D2D connection. Once the D2D connection is enabled 520c, the base station may then classify 530c traffic corresponding to the D2D connection as D2D traffic. As such, the traffic does not create excessive traffic in the cellular network.

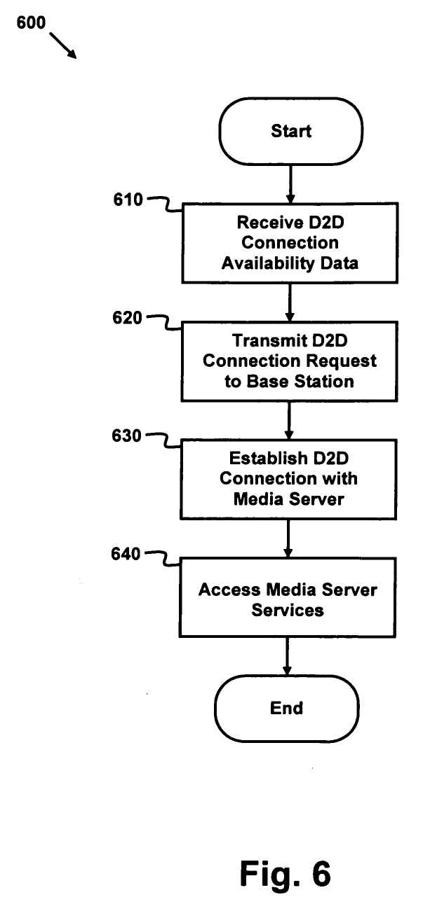

FIG. 6 is a flow chart diagram of a method 600 for a mobile terminal requesting and establishing a device-to-device connection, in accordance with an embodiment of the present invention. The depicted method 600 includes receiving 610 device-to-device (D2D) connection availability data, transmitting 620 a D2D connection request to a base station, establishing 630 a D2D connection with a media server, and accessing 640 media server services. In certain embodiments, the operations of the method 600 are performed by a mobile terminal. The operations of the method 600 provide one example of a method for enabling device-to-device connections and thereby creating an underlay network within a cellular network.

Receiving 610 D2D connection availability data may include a mobile terminal receiving advertisements regarding services provided by a media server. In some embodiments, receiving 610 may also include a user manually inputting a phone number, SIP address, or URL into the mobile phone. Transmitting 620 a D2D connection request to a base station may include the mobile phone executing a call or browse function corresponding to the connection availability data previously received. In certain embodiments, the base station enables a requested D2D connection request by communicating with the media server.

Establishing 630 a D2D connection with a media server may include the mobile terminal communicating with the media server via a Device-to-Device (D2D) radio. In certain embodiments, the D2D radio may be a long term evolution (LTE) D2D radio. Accessing 640 media server services may include downloading data from the media server and/or uploading data to the media server. Accordingly, the method 600 provides a solution for establishing a device-to-device connection between a mobile device and a media server merely by transmitting a request to do so.

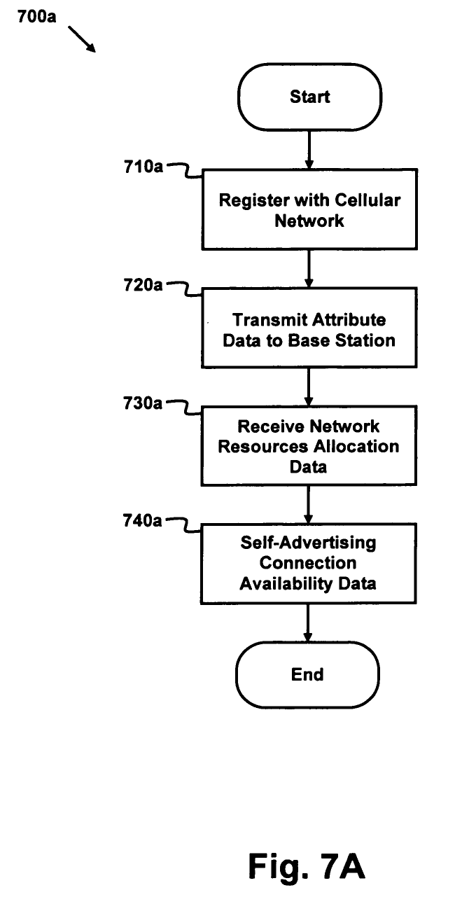

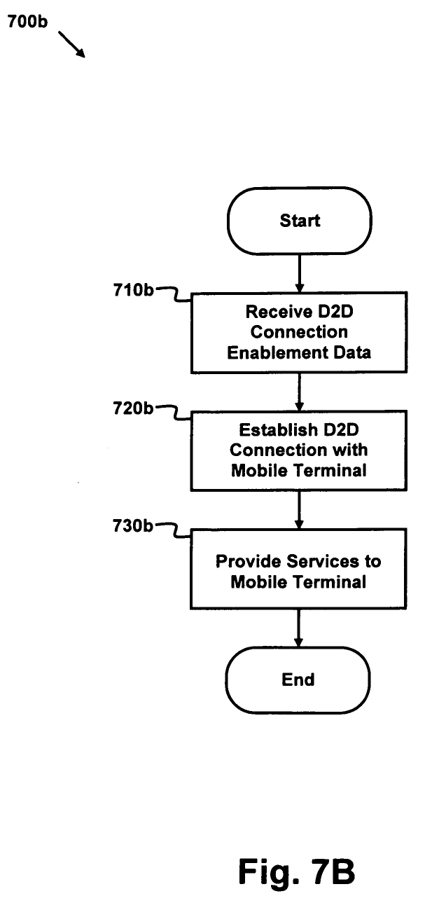

FIG. 7A is a flow chart diagram of a method 700a for a media server registering with a cellular network and self-advertising connection availability data in accordance with one embodiment of the present invention. The depicted method 700a includes registering 710a with a cellular network, transmitting 720a media server attribute data, receiving 730a network resources allocation data, self-advertising 740a connection availability data. In certain embodiments, the operations of the method 700a may be performed by a media server. In some embodiments, the receiving 730a of network resources allocation data and the self-advertising 740a of connection availability data are optional.

Registering 710a with a cellular network may include a media server registering with the cellular network by communicating with a base station. Transmitting 720a attribute data to a base station may include the media server providing data to the base station. The attribute data may include a capability of the media server to handle D2D traffic, whether the media server is likely to be the main source of traffic, whether mobile terminals connected via the device-to-device connections are likely to be the main source of traffic, how much traffic each mobile terminal is expected to generate, and an identifier (ID) of the media server.

Receiving 730a network resources allocation data may include a media server receiving a notice from the base station that resources have been assigned to the media server. In some embodiments, whether the receiving operation 730a is actually performed may depend on whether if there are already active mobile terminal media server connections or if the media server is allowed to self-advertise 740a.

FIG. 7B is a flow chart diagram of a method 700b for establishing a connection with and providing services to a mobile terminal in accordance with one embodiment of the present invention. The method 700b includes receiving 710b D2D connection enablement data, establishing 720b a D2D connection with a mobile terminal, and providing 730 services to the to mobile terminal. In certain embodiments, the operations of the method 700b are performed by a media server after the media server has been registered to a cellular network.

Receiving 710b D2D connection enablement data may include a media server receiving D2D connection setup information from the base station. In certain embodiments, the receiving 710b of the D2D connection enablement data occurs in response to a mobile device transmitting a request to a base station for a device-to-device connection with the media server. In some embodiments the mobile device transmitted the request in response to receiving connection availability data from the base station, the media server, or from a user. In some embodiments, the receiving 710b of the D2D connection enablement data occurs in response to a base station detecting D2D connection traffic in a cell of the base station or in a cell of a neighboring base station.

Establishing 720b a D2D connection with the mobile terminal may include using the D2D radio of the media server to communicate directly to the mobile terminal and not via the base station. After establishing 720b the D2D connection, the media server may provide 730b services to the mobile device in accordance with any number of possible media server services. Accordingly, the method 700b enables the establishment of a device-to-device connection between a media server and a mobile terminal in a manner that accounts for the appropriate allocation of cellular network resources.

One having ordinary skill in the art will readily understand that the invention as discussed above may be practiced with steps in a different order, and/or with hardware elements in configurations which are different than those which are disclosed. Therefore, although the invention has been described based upon these preferred embodiments, it would be apparent to those of skill in the art that certain modifications, variations, and alternative constructions would be apparent, while remaining within the spirit and scope of the invention. In order to determine the metes and bounds of the invention, therefore, reference should be made to the appended claims.

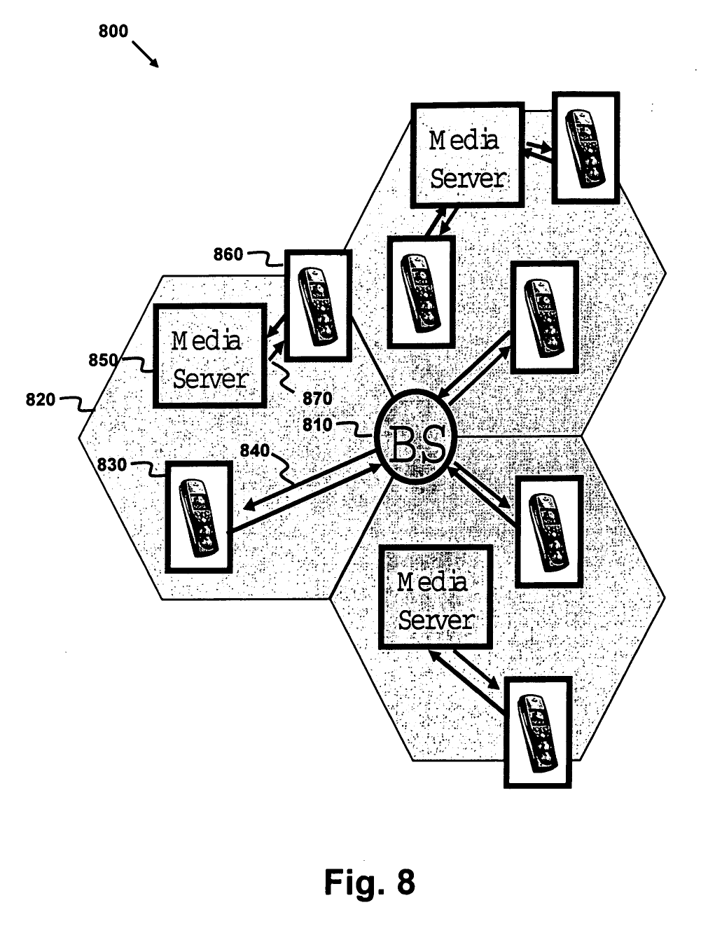

FIG. 8 is a block diagram of a system 800 with a single base station and multiple media servers in accordance with one embodiment of the present invention. The depicted system 800 includes a base station 810, media servers 850, and mobile terminals 830 and 860 all located in cell 820. The system 800 provides one example of a cellular network with multiple underlay networks. In another example the mobile terminals may be located in neighboring cells.

As depicted, the base station 810 may communicate with mobile device 820 in accordance with prevailing cellular network technology through connection 840. However, media server 850 is connected to the mobile terminal 860 via a device-to-device connection 870, thereby creating an underlay network within the cellular network. As such, the media server 850 and the mobile terminal 860 may communicate with one another without increasing cellular network traffic.

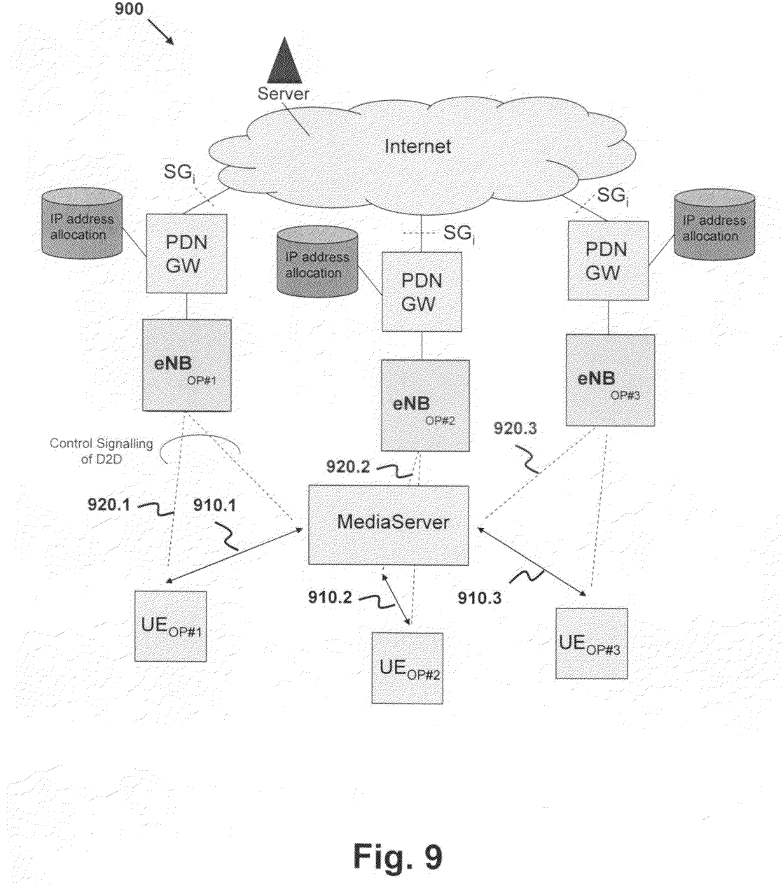

FIG. 9 is a block diagram of a system 900 with multiple base stations sharing a single media server, in accordance with the present invention. The depicted network 900 includes mobile terminals (UE), a media server, enhanced node Bs (eNB), packet data network gateways (PDN GW) connected to IP address allocation data stores, and the Internet. FIG. 9 provides one example of scenario where multiple operators use a single media server.

In one embodiment, the media server registers with only one operator in the network and all the mobile devices are required to use the operator network to which the media server is registered. In another embodiment, the media server may register with a first operator (OP#1) and the first operator coordinates with the other operators (OP#2 and OP#3) to enable device-to-device connections with the media server. In such an embodiment, the coordination between the operators may be facilitated via web services.

In a different embodiment, the media server is in communication with multiple network operators. In such an embodiment, the media server may use multiple cellular radios (e.g. Subscriber Information Modules (SIMS) for all local operators that support the D2D radio) or may register with all of the network operators using the same ID. Accordingly, the present invention enables a single media server to operate in an environment with many network operators.

It should be noted that reference throughout this specification to features, advantages, or similar language does not imply that all of the features and advantages that may be realized with the present invention should be or are in any single embodiment of the invention. Rather, language referring to the features and advantages is understood to mean that a specific feature, advantage, or characteristic described in connection with an embodiment is included in at least one embodiment of the present invention. Thus, discussion of the features and advantages, and similar language, throughout this specification may, but do not necessarily, refer to the same embodiment.

Furthermore, the described features, advantages, and characteristics of the invention may be combined in any suitable manner in one or more embodiments. One skilled in the relevant art will recognize that the invention can be practiced without one or more of the specific features or advantages of a particular embodiment. In other instances, additional features and advantages may be recognized in certain embodiments that may not be present in all embodiments of the invention.

We claim:

1. A method, comprising:
enabling a device-to-device connection between a media server and a mobile terminal by creating an underlay network within a cellular network, the underlay network comprising the mobile terminal in communication with the media server via the device-to-device connection.

2. The method of claim 1, further comprising:
receiving a request from the mobile terminal to establish the device-to-device connection with the media server.

3. The method of claim 1, further comprising:
detecting device-to-device traffic within the cellular network.

4. The method of claim 1, further comprising:
classifying traffic corresponding to device-to-device connections as device-to-device traffic.

5. The method of claim 1, further comprising:
communicating connection availability data to the mobile terminal, the connection availability data configured to indicate an opportunity to establish a device-to-device connection with the media server.

6. The method of claim 5, wherein the connection availability data comprises data associated with the media server.

7. The method of claim 6, wherein the data associated with the media server comprises at least one of a phone number, a session initiation protocol address, and a universal resource locator corresponding to the media server.

8. The method of claim 1, wherein the device-to-device connection is facilitated by a device-to-device radio of the media server and the mobile terminal.

9. The method of claim 1, further comprising:
registering the media server with the cellular network.

10. The method of claim 1, further comprising:
receiving attribute data from at least one of the media server and the mobile terminal.

11. The method of claim 1, further comprising:
determining an estimation of device-to-device traffic corresponding to the media server.

12. The method of claim 1, further comprising:
assigning resources for device-to-device connections.

13. The method of claim 1, further comprising:
coordinating with other networks to manage roaming mobile terminals establishing a device-to-device connection with the media server.

14. The method of claim 11, wherein the coordinating is facilitated by a web service.

15. The method of claim 1, wherein at least part of the enabling is performed by a base station in communication with the media server and the mobile terminal.

16. An apparatus, comprising:
a device-to-device connection enablement unit configured to enable a device-to-device connection between a media server and a mobile terminal to create an underlay network within a cellular network, the underlay network comprising the mobile terminal in communication with the media server via the device-to-device connection.

17. The apparatus of claim 16, further comprising:
a reception unit configured to receive a request from the mobile terminal to establish the device-to-device connection with the media server.

18. The apparatus of claim 16, further comprising:
a device-to-device traffic detection unit configured to detect device-to-device traffic within the cellular network.

19. The apparatus of claim 16, further comprising:
a traffic classification unit configured to classify traffic corresponding to device-to-device connections as device-to-device traffic.

20. The apparatus of claim 16, further comprising:
a transmission unit configured to transmit connection availability data to the mobile terminal, the connection availability data configured to indicate an opportunity to establish a device-to-device connection with the media server.

21. The apparatus of claim 20, wherein the connection availability data comprises data associated with the media server.

22. The apparatus of claim 21, wherein the data associated with the media server comprises at least one of a phone number, a session initiation protocol address, and a universal resource locator corresponding to the media server.

23. The apparatus of claim 16, wherein the device-to-device connection is facilitated by a device-to-device radio of the media server and the mobile terminal.

24. The apparatus of claim 16, further comprising:
a registration unit configured to register the media server with the cellular network.

25. The apparatus of claim 16, further comprising:
a reception unit configured to receive attribute data from at least one of the media server and the mobile terminal.

26. The apparatus of claim 16, further comprising:
a device-to-device estimation unit configured to determine an estimation of device-to-device traffic corresponding to the media server.

27. The apparatus of claim 16, further comprising:
a resource assignment unit configured to assign network resources for device-to-device connections.

28. The apparatus of claim 16, further comprising:
a roaming terminal unit configured to manage roaming mobile terminals establishing a device-to-device connection with the media server.

29. The apparatus of claim 28, wherein management of the roaming mobile-terminals is facilitated by a web service.

30. The apparatus of claim 16, wherein the apparatus comprises a base station in communication with the media server and the mobile terminal.

31. An apparatus, comprising:
means for enabling a device-to-device connection between a media server and a mobile terminal to create an underlay network within the cellular network, the underlay network comprising the mobile terminal in communication with the media server via the device-to-device connection.

32. A computer program embodied on a computer-readable medium, the computer program configured to control a processor to perform operations comprising:
enabling a device-to-device connection between a media server and a mobile terminal to create an underlay network within the cellular network, the underlay network comprising the mobile terminal in communication with the media server via the device-to-device connection.

33. A method, comprising:
establishing a device-to-device connection with a media server to create an underlay network within a cellular network, the underlay network comprising the device-to-device connection with the media server.

34. The method of claim 33, further comprising:
transmitting a request to a base station to establish the device-to-device connection with the media server, wherein the base station is configured to enable the device-to-device connection

35. The method of claim 34, wherein the transmitting of the request comprises transmitting data corresponding to at least one of a phone number, a session initiation protocol address, and a universal resource locator corresponding to the media server.

36. The method of claim 33, further comprising:
receiving connection availability data from a base station, the connection availability data configured to indicate an opportunity to establish a device-to-device connection with the media server.

37. The method of claim 33, wherein the establishing of the device-to-device connection comprises using a local device-to-device radio to communicate with a device-to-device radio of the media server.

38. The method of claim 33, wherein at least part of the establishing is performed by a mobile terminal in the cellular network.

39. An apparatus, comprising:
a device-to-device connection establishment unit configured to establish a device-to-device connection with a media server to create an underlay network within a cellular network, the underlay network comprising the device-to-device connection with the media server.

40. The apparatus of claim 39, further comprising:
a transmission unit configured to transmit a request to a base station of the cellular network to establish a device-to-device connection with the media server, wherein the base station is configured to enable the device-to-device connection.

41. The apparatus of claim 40, wherein the request comprises transmitting data corresponding to at least one of a phone number, a session initiation protocol address, and a universal resource locator corresponding to the media server.

42. The apparatus of claim 39, wherein traffic corresponding to the device-to-device connection is classified as device-to-device traffic by the base station.

43. The apparatus of claim 39, further comprising:
a reception unit configured to receive connection availability data from a base station, the connection availability data configured to indicate an opportunity to establish a device-to-device connection with the media server.

44. The apparatus of claim 39, wherein the device-to-device connection establishment unit is configured to establish the device-to-device connection by using a local device-to-device radio to communicate with a device-to-device radio of the media server.

45. The apparatus of claim 39, wherein the apparatus comprises a mobile terminal in the cellular network.

46. An apparatus, comprising:
means for establishing a device-to-device connection with a media server to create an underlay network within the cellular network, the underlay network comprising the device-to-device connection with the media server.

47. A computer program embodied on a computer-readable medium, the computer program configured to control a processor unit to perform operations comprising:
establishing a device-to-device connection with a media server to create an underlay network within the cellular network, the underlay network comprising the device-to-device connection with the media server.

48. A method, comprising:
establishing a device-to-device connection with the mobile device to create an underlay network within the cellular network, the underlay network comprising the device-to-device connection with the mobile device.

49. The method of claim 48, further comprising:
receiving device-to-device connection enablement data regarding the mobile terminal from a base station of the cellular network.

50. The method of claim 48, further comprising:
communicating connection availability data to enable establishment of the device-to-device connection with the mobile device.

51. The method of claim 48, further comprising:
advertising connection availability data to enable establishment of the device-to-device connection with the mobile device.

52. The method of claim 51, wherein the connection availability data comprises at least one of a phone number, a session initiation protocol address, and a universal resource locator corresponding to the media server.

53. The method of claim 48, wherein the establishing of the device-to-device connection comprises using a local device-to-device radio to communicate with a local device-to-device radio of the mobile terminal.

54. The method of claim 48, further comprising:
registering with the cellular network.

55. The method of claim 48, further comprising:
communicating attribute data to the base station.

56. The method of claim 48 wherein the establishing is performed by a media server in the cellular network.

57. An apparatus, comprising:
a device-to-device connection unit configured to establish a device-to-device connection with a mobile device to create an underlay network within the cellular network, the underlay network comprising the device-to-device connection with the mobile device.

58. The apparatus of claim 57, further comprising:
a reception unit configured to receive device-to-device connection enablement data regarding the mobile terminal from a base station of the cellular network.

59. The apparatus of claim 57, further comprising:
a display unit configured to communicate connection availability data to enable establishment of the device-to-device connection with the mobile device.

60. The apparatus of claim 57, further comprising:
a display unit configured to advertise connection availability data to enable establishment of the device-to-device connection with the mobile device.

61. The apparatus of claim 60, wherein the connection availability data comprises at least one of a phone number, a session initiation protocol address, and a universal resource locator corresponding to the media server.

62. The apparatus of claim 57, wherein the device-to-device connection unit is configured to establish the device-to-device connection by using a local device-to-device radio to communicate with a local device-to-device radio of the mobile terminal.

63. The apparatus of claim 57, further comprising:
a reception unit and a transmission unit configured to enable the apparatus to register with the cellular network.

64. The apparatus of claim 57, further comprising:
a transmission unit configured to transmit attribute data to the base station.

65. The apparatus of claim 57, wherein the apparatus comprises a media server in the cellular network.

66. An apparatus, comprising:
means for establishing a device-to-device connection with a mobile device to create an underlay network within the cellular network, the underlay network comprising the device-to-device connection with the mobile device.

67. A computer program embodied on a computer-readable medium, the computer program configured to control a processor to perform operations comprising:
establishing a device-to-device connection with a mobile device to create an underlay network within the cellular network, the underlay network comprising the device-to-device connection with the mobile device.

68. A mobile terminal, comprising:
a device-to-device connection unit configured to establish a device-to-device connection with a mobile device to create an underlay network within the cellular network, the underlay network comprising the device-to-device connection with the mobile device, wherein the mobile terminal operates as a media server.

69. A system, comprising:
a base station of a cellular network;
a mobile terminal; and
a media server,
wherein the base station is configured to enable a device-to-device connection between the media server and the mobile terminal,
wherein the mobile terminal and the media server are configured to establish the device-to-device connection to create an underlay network within the cellular network, the underlay network comprising the mobile terminal, the media server, and the device-to-device connection.
